(19) United States
(12) Patent Application Publication
(10) Pub. No.: US 2026/0251875 A1
(43) Pub. Date: Aug. 27, 2026

(54) FIBER OPTIC MODULE WITH REFLECTOR DEVICES

(71) Applicant: CORNING RESEARCH & DEVELOPMENT CORPORATION, CORNING, NY (US)

(72) Inventors: Wojciech Piotr Giziewicz, Berlin (DE); Agnieszka Maria Kruk-Kaminska, Lódz (PL); Magdalena Czeslawa Przemyska, Lodz (PL); Piotr Michal Szewczyk, Lodz (PL); Marcin Lukasz Tomaszewski, Lodz (PL)

(21) Appl. No.: 19/548,009

(22) Filed: Feb. 24, 2026

Related U.S. Application Data
(60) Provisional application No. 63/762,382, filed on Feb. 24, 2025.

(51) Int. Cl. G02B 6/44

(52) U.S. Cl. CPC G02B 6/4446

(57) ABSTRACT

A fiber optic module includes a main body, first fiber optic adapters disposed through a front side of the main body, first fiber optic connectors received in the first fiber optic adapters, and reflector devices that are disposed inside an internal chamber of the main body and each associated with a respective first fiber optic connector. Input optical fibers extend from a rear side of the main body to the reflector devices, and output optical fibers extend from the reflector devices to the first fiber optic connectors. Each of the output optical fibers has a substantially similar length. The reflector devices allow for conventional use of the module in a network and provide network testing capabilities without requiring new modules, new cabling, or separate installation.

### RELATED APPLICATIONS

This application claims the benefit of priority of U.S. Provisional Application Serial No. 63/762,382 filed on February 24, 2025, the content of which is relied upon and incorporated herein by reference in its entirety.

### TECHNICAL FIELD

This disclosure relates generally to fiber optic connectivity, and more particularly to a fiber optic module with reflector devices that helps enable unique network testing capabilities.

### BACKGROUND

In fast-paced financial markets, the speed at which data is transmitted can significantly impact decision-making and profitability. Financial institutions and stock exchanges rely on high-speed communication networks to execute trades, process transactions, and manage data-intensive applications. Optical fiber has become the backbone of these networks due to its unparalleled advantages over traditional copper-based systems. Two primary advantages are high bandwidth and low latency.

Although optical fiber cables and equipment are used extensively in communication networks, institutions and organizations involved in high-frequency trading or other latency-sensitive operations constantly seek to improve and/or test their networks for latency. Various types of equipment and optical fiber products exist for this purpose. However, existing products do not meet the needs for all applications and networks, which can vary in terms of topology and equipment used. Optical communication products that easily integrate into networks and allow for latency to be check in a more effective way are desired by some industries, such as the financial industry.

### SUMMARY

A fiber optic module comprises a main body having a front side, a rear side, and opposed lateral walls. The main body further includes an internal chamber bounded at least in part by the front side, the rear side, and the opposed lateral walls. The fiber optic module also includes: a plurality of first fiber optic connectors each received in one of the first fiber optic adapters; a plurality of reflector devices disposed inside the internal chamber at a location behind the first fiber optic connectors, wherein each reflector device is associated with a respective first fiber optic connector; a plurality of input optical fibers each extending from the rear side of the main body to a respective one of the reflector devices; and a plurality of output optical fibers each extending from a respective one of the reflector devices to the associated first fiber optic connector. Each output optical fiber has a length measured from the respective reflector device to an end of the associated first fiber optic connector, and such lengths of the output optical fibers are substantially similar. Each input optical fiber is configured to carry to the respective reflector device optical signals in a first wavelength range and a second wavelength range that is different than the first wavelength range. Additionally, each of the reflector devices is configured to: (a) pass the optical signals in the first wavelength range from the respective input optical fiber to the respective output optical fiber, and (b) reflect the optical signals in the second wavelength range back to the respective input optical fiber.

Additional features and advantages will be set forth in the detailed description which follows, and in part will be readily apparent to those skilled in the technical field of optical connectivity. The foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description explain principles and operation of the various embodiments. Features and attributes associated with any of the embodiments shown or described may be applied to other embodiments shown, described, or appreciated based on this disclosure.

FIG. 1 is an exploded perspective view of one example of a known fiber optic module.

FIG. 2 is a perspective view of one example of a module according to this disclosure, wherein the module includes a plurality of reflector devices.

FIG. 3 is an exploded perspective view of the module of FIG. 2.

FIG. 4 is a side elevation view of a first fiber optic connector, reflector device, and output optical fiber that may be used as part of the module of FIGS. 2 and 3.

FIG. 5 is a schematic top view of the module of FIG. 2 showing only one reflector device and an input optical fiber for that reflector device.

### DETAILED DESCRIPTION

The present disclosure provides a fiber optic module (sometimes referred to as a cassette) that can be used to efficiently test aspects of the fiber optic network in which the fiber optic module is used. The fiber optic module includes a particular arrangement of unique components within a module body, which may advantageously be configured to be used with the same equipment that supports other, conventional fiber optic modules used in the fiber optic network. One example of a conventional fiber optic module will be described first below for additional context before describing the new fiber optic modules provided by this disclosure.

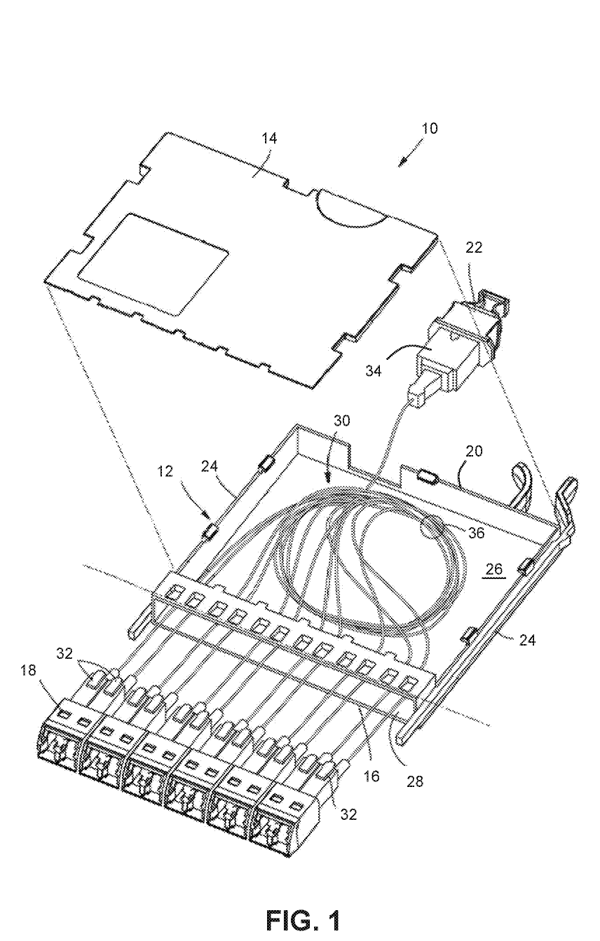

In general, pieces of equipment in a fiber optic network may as junction points between different optical fiber cables. At these junction points it is often necessary to breakout optical signals from one cable to smaller groups of the optical signals (or even individual optical signals), which may then be carried by a larger number of other cables for further distribution in the network. A fiber optic module, such as that shown in FIG. 1 (“module 10”) and sometimes referred to as a cassette, is one example of a piece of fiber optic equipment that is used to breakout optical signals in this manner. FIG. 1 is an exploded view to better show the various components of the module 10.

As shown in FIG. 1, the module 10 includes a main body 12 and a cover 14 that is configured to couple to the main body 12. The main body 12 has a front side 16 configured to support adapters 18 in at least one front opening 28, a rear side 20 configured to support an adapter 22, opposed lateral walls 24, and an internal chamber 26 bounded at least in part by the front side 16, the rear side 20, and the opposed lateral walls 24. The adapters 18, 22 are for interfacing with fiber optic connectors (not shown) of cables that extend to or from the module 10. In the embodiment shown, the adapters 18 are configured to interface with simplex or duplex LC connectors, whereas the adapter 22 is a multifiber adapter configured to interface with multifiber push on / pull off (MPO) connectors. The present disclosure is not limited to such connector and adapter types, however, as skilled persons will appreciate how other types may be used. Additionally, the number of connectors and adapters on the front side and/or rear side may be different than what is shown.

Within the internal chamber 26, a fiber optic harness 30 establishes connections between the adapters 18 on the front side 16 and the adapter 22 on the rear side 20. The fiber optic harness 30 includes first fiber optic connectors 32 (“first connectors 32”) that each plug into an inward-facing side of one of the adapters 18, a second fiber optic connector 34 (“second connector 34”) that plugs into an inward-facing side of the adapter 22, and optical fibers 36 extending between the second connector 34 and the first connectors 32. Accordingly, each optical fiber 36 has one end that terminates at the second connector 34 and another end that terminates at one of the first connectors 32. The optical fibers 36 typically include one or more coating layers to protect bare glass that is configured for optical signal transmission. Which optical fiber 36 extends to which first connector 32 may vary depending on the desired scheme for optical signal routing. The optical fibers 36 typically have a longer length than the direct path between their associated connectors 32, 34, so the optical fibers 36 are typically looped one or more times within the internal chamber 26 to accommodate the excess length.

The module 10 is configured to be received in other fiber optic equipment that is not shown, such as a housing or enclosure that is mounted to an equipment rack. These aspects are well-known to persons skilled in optical communication network design.

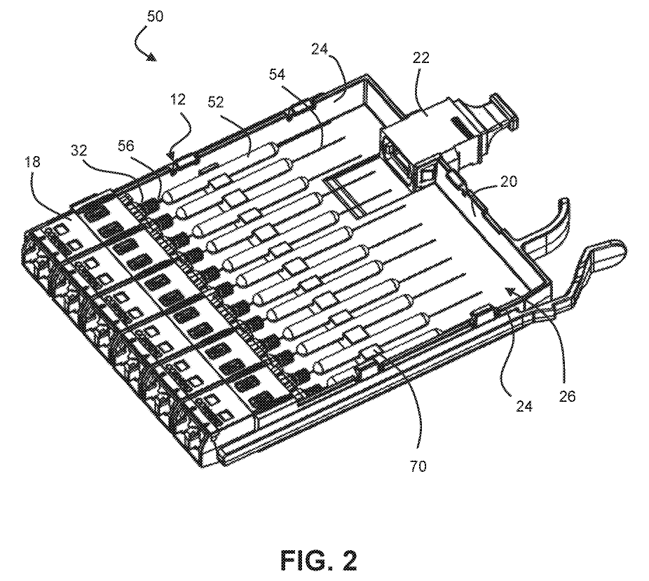

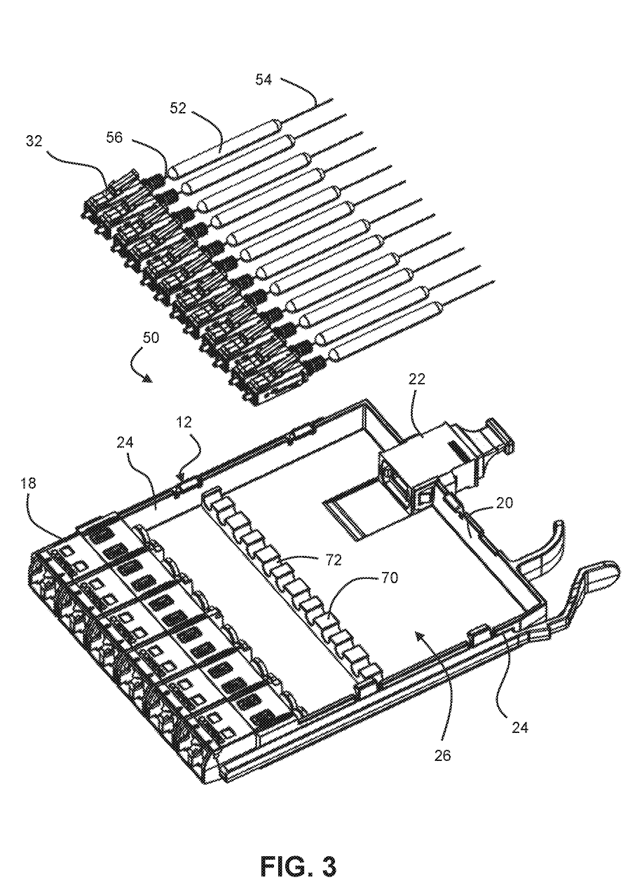

Now referring to FIGS. 2 and 3, one example of a module 50 according to this disclosure is shown. The module 50 has the same main body 12 (and cover 14, which is not shown) and adapters 18, 22 as the module 10 (FIG. 1) such that similar reference numbers are used to refer to components discussed above in connection with the module 10. Only the differences provided by the module 50 will be described.

To this end, the module 50 includes a plurality of reflector devices 52 disposed inside the internal chamber 26 at a location behind the first connectors 32. In general, each reflector device 52 is configured to receive optical signals that are carried by a respective input optical fiber 54 to the reflector device 52. The optical signals may include optical signals in a first wavelength range and optical signals in a second wavelength range that is different than the first wavelength range. The reflector devices 52 are each configured to: (a) pass the optical signals that are in the first wavelength range from the respective input optical fiber 54 to a respective output optical fiber 56 for further transmission, and (b) reflect the optical signals that are in the second wavelength range back into the respective input optical fiber 54. The reflected light may be transmitted back through the optical network back to a network testing device that can assess network characteristics, such as latency of the optical link between the testing device and the reflector device 52.

Various types of “in-line” reflector devices that operate in the manner described above are known, such as reflector devices based on thin film filter technology and reflector devices based on fiber bragg grating technology. This disclosure is not directed to the details of such reflector devices themselves, and instead is directed to the unique way in which they are used as part of the module 50 to provide a novel network testing solution.

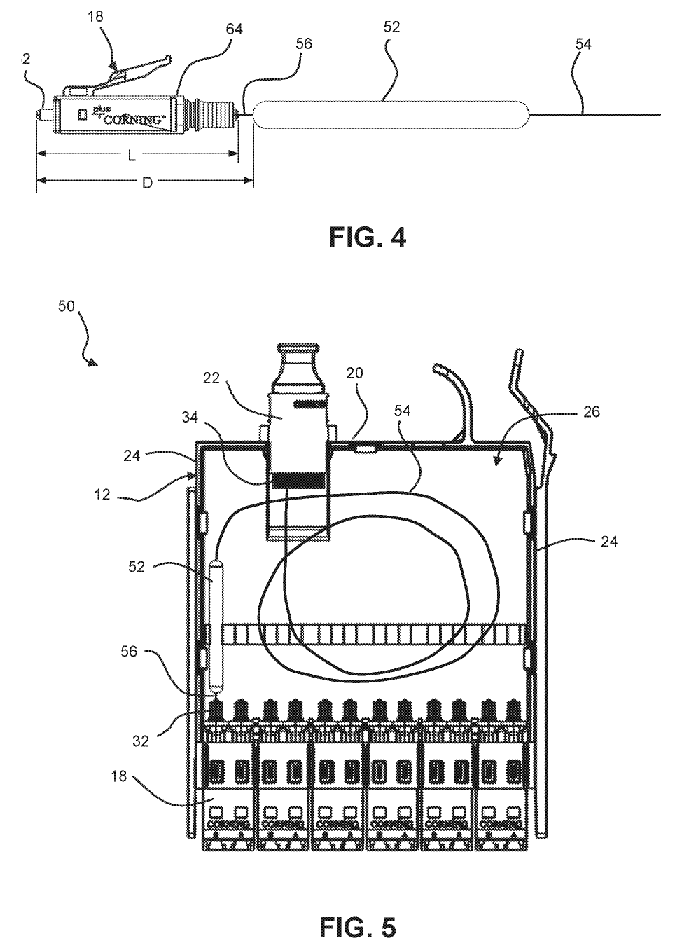

Still referring to FIGS. 2 and 3, and as already mentioned, each reflector device 52 is associated with respective input optical fiber 54 and a respective output optical fiber 56. The input optical fibers 54 extend from the rear side 20 of the main body 12 to the reflector devices 52. Although the input optical fibers 54 are only shown in FIGS. 2 and 3 as having a short length and extending in a straight line, this is merely for convenience to simplify the drawings. In reality the input optical fibers 54 may have a longer length extending from the reflector devices 52 and be looped one or more times within the internal chamber 26 (like the optical fibers 36 of FIG. 1) before extending to the rear side 20. For example, FIG. 4 schematically the module 50 with a representative reflector device 52 and representative input optical fiber 54 looping within the internal chamber 26 as the input optical fiber 54 extends between the second connector 34 (shown schematically in FIG. 4) and the reflector device 52. This routing of the input optical fibers 54 may occur above other components that may be present (e.g., reflector devices 52) yet still be contained within the internal chamber 26. The connector 34 is not shown in FIGS. 2 and 3, like the complete length of the input optical fibers 54, to simplify the drawings.

The output optical fibers 56 each extend from a respective one of the reflector devices 52 to the associated first connector 32. Only a very small length of each output optical fiber 56 is visible in FIGS. 2 and 3. FIG. 5 illustrates a representative first connector 32, output optical fiber 56, and reflector device 52 in isolation to better appreciate the relationship between these elements.

As shown in FIG. 5, the first connector 32 includes a ferrule 62 and a connector body 64. The ferrule 62 is the element of the first connector 32 that terminates the output optical fiber 56 and thereby presents an end of the output optical fiber 56 for optical coupling to another component (e.g., another fiber optic connector). The connector body 64 is the primary structure that is designed for mechanical coupling with another component (e.g., one of the adapters 18) and includes a back end. Thus, the output optical fiber 56 extends from the reflector device 52, into the back end of the connector body 64, and ends at the front of the ferrule 62.

The output optical fiber 56 has a very short length in the embodiment shown. The reflector device 52 is therefore positioned very close to the first connector 32, e.g. immediately behind the connector body 64. Additional connector components that are typically attached to back of the connector body 64, such as a crimp band for securing strength elements from a cable and a boot (strain relief) to cover the transition to a cable, are not provided in the embodiment to help allow the reflector device 52 to be positioned closer to the connector body 64. However, alternative embodiments are possible in which such components are still provided.

In some embodiments, including the embodiment shown, a very short section of the output optical fiber 56 may be exposed between the reflector device 52 and the back end of the connector body 64. The optical fiber may include a coating in this exposed section, but the coating may be kept relatively small. For example, the output optical fiber 56 may include an acrylic coating that covers glass material of the output optical fiber 56, but the acrylic coating may only be about 250 or 200 microns in diameter, or potentially even less. The output optical fiber 56 therefore remains delicate compared to optical fibers with larger protective coatings or optical fibers covered with larger protective tubes (e.g., such coatings or tubes being 900 microns in diameter).

The positional relationships just described can be expressed using the labels illustrated in FIG. 5. In particular, FIG. 5 illustrates the first connector 32 having a length L measured from the front end of the ferrule 62 (which is also where the end of the output optical fiber 56 is located) to the back end of the connector body 64. The reflector device 52 is labeled as being positioned at a distance D from the front end of the ferrule 62. The distance D also corresponds to the length of the output optical fiber 56 from the reflector device 52 to the end of the output optical fiber 56 since that end is at the front end of the ferrule 62. Both the length L and distance D are measured in a direction parallel to a longitudinal axis of the first connector 32. The distance D may be less than 25% larger than the length L, i.e. the distance D may be between about 1 to 1.25 times the length L. As a specific example, the length L may be about 2.3 centimeters, the distance D may be about 2.8 centimeters, and the exposed section of the output optical fiber may be about 0.5 centimeters.

Although only a representative first connector 32 and reflector device 52 are shown in FIG. 5, the other first connectors 32 and reflector devices 52 may be constructed with the same positional relationships in mind. As a result, and as shown in FIGS. 2 and 3, each reflector device 52 may be positioned within the internal chamber 26 of the main body 12 at a substantially similar distance from the associated first connector 32. The distance D is therefore substantially the same (e.g., within 10% of each other) for each output optical fiber 56. Another way to state the relationship is that the output optical fibers 56 each have a length that is very close to a target value. For example, the output optical fibers 56 may all be within 0.2 centimeters of a target value in some embodiments, 0.1 centimeters of a target value in some embodiments, etc. In some embodiments, the output optical fibers 56 have lengths that are all within 0.2 centimeters of each other.

As shown in FIGS. 2, 3, and 5, the module 50 may also include a support structure 70 that holds each reflector device 52 behind its associated first connector 32. The support structure 70 may be a separate element that is coupled to the main body 12 and arranged to extend across a width of the internal chamber 26. In the embodiment shown, the support structure 70 includes spaced-apart grooves or channels 72 that are shaped to receive the reflector devices 52. The support structure 70 helps align each reflector device 52 with its associated first connector 32 substantially along the longitudinal axis of the associated first connector 32.

In terms of use, a network owner/operator may install the module 50 in a network in the same manner as the module 10 (or other conventional modules). The module 50 may even be used like the module 10 to route optical signals in a desired manner between different cables and/or equipment. An upstream network cable (not shown) may be terminated with a multifiber connector that gets plugged into the second adapter 22 and optical couples to the second connector 34. Similarly, downstream network cables (not shown) may be terminated with simplex or duplex connectors that get plugged into the front of the adapters 18 and that optically couple with respective first connectors 32. The coupling process can result in the ferrules 62 of the first connectors 32 being pushed backwards a small amount. This can also cause the output optical fibers 56 to be pushed back slightly since they each have an end secured to one of the ferrules 62. Advantageously, the support structure 70 may be configured to allow movement of each reflector device 52 in a direction substantially aligned with the longitudinal axis of the associated first connector 32. Such a feature can help reduce the risk of the output optical fibers 56 breaking or otherwise failing when connections are established.

Note that the type of use referred to above requires optical signals to be in a wavelength range that the reflector devices 52 are configured to pass to the output optical fibers 56. This is referred to as a “first wavelength range” earlier in this description. Aside from the use referred to above, the module 50 has the advantage of also allowing the network owner/operator to perform certain testing of the network using a different wavelength range, i.e. a second wavelength range.

For example, the network owner can have equipment in the network send optical signals in the second wavelength range to the input optical fibers 54. The input optical fibers 54 receive the optical signals from upstream portions of the optical links to which the input optical fibers 54 belong, and the input optical fibers 54 then transmit those optical signals to the reflector devices 52. Because the optical signals are in the second wavelength range, the reflector devices 52 direct those optical signals back into the input optical fibers 54 for further transmission back upstream. The network testing equipment may receive the optical signals and make determinations about how much time it takes for optical signals to travel through the optical links to the reflector devices 52. The unique arrangement of the reflector devices 52 and integration as part of the module 50 provide extra functionality or effectiveness to this type of latency testing.

In particular, by positioning the reflector devices 52 as close as possible to the first connectors 32, the latency (or “time of flight”) of the optical links to the first connectors 32 becomes more accurate. Additionally, because each reflector device 52 is positioned within the internal chamber 26 at a substantially similar distance from the associated first connector 32, latency measurements between optical links can be compared. Some network owners, such as those that use their networks for operating stock exchanges, need to take great care to ensure that optical links are configured in a uniform manner so that none of their customers receive a network advantage over other customers. Therefore, the module 50 provides a convenient way for these network operators to test if any optical link associated with the module 50 has a latency advantage compared to other optical links. This testing may be done not only as part of commissioning the network, but also during operation of the network. Hundreds or thousands of modules like the module 50 may be used in the network, and the modules 50 have the advantage of allowing for in-situ testing. No separate installation or connecting is required to perform testing after commissioning the network.

It will be apparent to those skilled in optical connectivity that various modifications and variations can be made based on this disclosure. For example, although the module 50 is illustrated as having a second adapter 22, in alternative embodiments the input optical fibers 54 may extend directly from a cable that passes through the rear side 20 of the main body 12. Thus, this disclosure in its broader aspects is not limited to the specific details of example embodiments shown or described. Other embodiments are possible without departing from the scope of the claims below.

What is claimed is:

1. A fiber optic module, comprising:
a main body having a front side, a rear side, and opposed lateral walls, wherein the main body further includes an internal chamber bounded at least in part by the front side, the rear side, and the opposed lateral walls;
a plurality of first fiber optic adapters disposed through the front side of the main body;
a plurality of first fiber optic connectors each received in one of the first fiber optic adapters;
a plurality of reflector devices disposed inside the internal chamber at a location behind the first fiber optic connectors, wherein each reflector device is associated with a respective first fiber optic connector;
a plurality of input optical fibers each extending from the rear side of the main body to a respective one of the reflector devices; and
a plurality of output optical fibers each extending from a respective one of the reflector devices to the associated first fiber optic connector, wherein each of the output optical fibers has a length measured from the respective reflector device to an end of the output optical fiber, and wherein the lengths of the output optical fibers are substantially similar;
wherein each of the input optical fibers is configured to carry to the respective reflector device optical signals in a first wavelength range and a second wavelength range that is different than the first wavelength range; and
wherein each of the reflector devices is configured to: (a) pass the optical signals in the first wavelength range from the respective input optical fiber to the respective output optical fiber, and (b) reflect the optical signals in the second wavelength range back to the respective input optical fiber.

2. The fiber optic module of claim 1, wherein each reflector device is positioned within the internal chamber at a substantially similar distance from the associated first fiber optic connector.

3. The fiber optic module of claim 1, wherein the fiber optic module further comprises:
a support structure coupled to the main body, wherein the support structure holds each reflector device behind the associated first fiber optic connector such that each reflector device is aligned with the associated first fiber optic connector in a longitudinal direction.

4. The fiber optic module of claim 3, wherein the support structure is configured to allow movement of each reflector device in the longitudinal direction.

5. The fiber optic module of claim 1, wherein each output optical fiber comprises an exposed section between the respective reflector device and the associated first fiber optic connector, and wherein the expose section has a diameter of 250 microns or less.

6. The fiber optic module of claim 1, wherein the lengths of the output optical fibers are within 0.2 centimeters (cm) of each other.

7. The fiber optic module of claim 1, wherein the lengths of the output optical fibers are within 0.2 centimeters (cm) of a target value.

8. The fiber optic module of claim 1, wherein the lengths of the output optical fibers are within 0.1 centimeters (cm) of a target value.

9. The fiber optic module of claim 1, wherein:
each of the first fiber optic connectors has a length L between a front end and a back end of the first fiber optic connector;
each of the reflector devices is positioned a distance D from the front end of the associated first fiber optic connector; and
D is between 1 to 1.25 times L.

10. The fiber optic module of claim 1, wherein each of the first fiber optic connectors comprises an LC connector.

11. The fiber optic module of claim 1, wherein the fiber optic module further comprises:
at least one second fiber optic adapter disposed through the rear side of the main body; and
at least one second fiber optic connector, wherein each second fiber optic connector is received in a respective second fiber optic adapter of the at least one second fiber optic adapter, and wherein each second fiber optic connector terminates at least several of the output optical fibers.

12. The fiber optic module of claim 11, wherein each second fiber optic connector of the at least one second fiber optic connector comprises a multifiber push-on (MPO) connector.

13. The fiber optic module of claim 11, wherein the at least one second fiber optic adapter comprises only one second fiber optic adapter and the at least one second fiber optic connector comprises only one second fiber optic connector, and wherein each of the output optical fibers is terminated by the second fiber optic connector.

14. The fiber optic module of claim 1, wherein the reflector device comprises a thin film filter device.

15. The fiber optic module of claim 1, wherein the reflector device comprises a fiber bragg grating device.

16. A fiber optic module, comprising:
a main body having a front side, a rear side, and opposed lateral walls, wherein the main body further includes an internal chamber bounded at least in part by the front side, the rear side, and the opposed lateral walls;
a plurality of first fiber optic adapters disposed through the front side of the main body;
a plurality of first fiber optic connectors each received in one of the first fiber optic adapters, wherein each first fiber optic connector of the plurality of first fiber optic connectors includes a ferrule;
a plurality of reflector devices disposed inside the internal chamber at a location behind the first fiber optic connectors, wherein each reflector device is associated with a respective first fiber optic connector;
a plurality of input optical fibers each extending from the rear side of the main body to a respective one of the reflector devices; and
a plurality of output optical fibers each extending from a respective one of the reflector devices to the associated first fiber optic connector, wherein each of the output optical fibers is terminated by the ferrule of the associated first fiber optic connector such that the ferrule presents an end of the output optical fiber for optical coupling, and wherein each of the output optical fibers has a length measured from the respective reflector device to the end of the output optical fiber, and wherein the lengths of the output optical fibers are substantially similar;
wherein each of the input optical fibers is configured to carry to the respective reflector device optical signals in a first wavelength range and a second wavelength range that is different than the first wavelength range; and
wherein each of the reflector devices is configured to: (a) pass the optical signals in the first wavelength range from the respective input optical fiber to the respective output optical fiber, and (b) reflect the optical signals in the second wavelength range back to the respective input optical fiber.

17. The fiber optic module of claim 16, wherein the fiber optic module further comprises:
a support structure coupled to the main body, wherein the support structure holds each reflector device behind the associated first fiber optic connector such that each reflector device is aligned with the associated first fiber optic connector in a longitudinal direction, and wherein the support structure is configured to allow movement of each reflector device in the longitudinal direction.

18. The fiber optic module of claim 16, wherein the lengths of the output optical fibers are within 0.2 centimeters (cm) of each other.

19. The fiber optic module of claim 1, wherein:
each of the first fiber optic connectors has a length L between a front end that is defined by the ferrule of the first fiber optic connector and a back end of the first fiber optic connector;
each of the reflector devices is positioned a distance D from the front end of the associated first fiber optic connector; and
D is between 1 to 1.25 times L.

20. The fiber optic module of claim 16, wherein the fiber optic module further comprises:
at least one second fiber optic adapter disposed through the rear side of the main body; and
at least one second fiber optic connector, wherein each second fiber optic connector is received in a respective second fiber optic adapter of the at least one second fiber optic adapter, and wherein each second fiber optic connector terminates at least several of the output optical fibers.
